(19) United States
(12) Patent Application Publication
(10) Pub. No.: US 2019/0139422 A1
(43) Pub. Date: May 9, 2019

(54) COMPANION DRONE TO ASSIST LOCATION DETERMINATION

(71) Applicants: Wee Hoo Cheah, Nangang Dist (TW); David W. Browning, Beaverton, OR (US)

(72) Inventors: Wee Hoo Cheah, Nangang Dist (TW); David W. Browning, Beaverton, OR (US)

(21) Appl. No.: 16/235,164

(22) Filed: Dec. 28, 2018

(51) Int. Cl. G08G 5/00; G01C 21/00

(52) U.S. Cl. CPC G08G 5/0008; G08G 5/0069; G01C 21/005

(57) ABSTRACT

A drone positioning system includes a processor subsystem and memory comprising instructions, which when executed by the processor subsystem, cause the processor subsystem to perform the operations comprising: transmitting, from an operation drone, a request message to a plurality of companion drones; receiving a response message from each of the plurality of companion drones, each response message including: a first timestamp indicating when the response message was sent from the corresponding companion drone and a first geoposition of the corresponding companion drone; calculating a first distance to each of the plurality of companion drones using the first timestamps of respective response messages from each of the plurality of companion drones; calculating an estimated geoposition of the operation drone from the respective first distances and the respective first geopositions of the companion drones; and assisting navigation of the operation drone using the estimated geoposition.

### TECHNICAL FIELD

Embodiments described herein generally relate to autonomous robots, and in particular, to systems and methods for use of a companion drone to assist location determination.

### BACKGROUND

Autonomous robots, which may also be referred to or include drones, unmanned aerial vehicles, and the like, are vehicles that operate partially or fully without human direction. Autonomous robots use geo-positioning for a variety of purposes including navigation, mapping, and surveillance.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a drone, according to an embodiment;

FIG. 2 is a diagram illustrating trilateration with three companion drones, according to an embodiment;

FIGS. 3A-3B are diagrams illustrating trilateration with two companion drones, according to various embodiments;

FIG. 4 is a flowchart illustrating a method for geo-positioning using three or more companion drones, according to an embodiment;

FIG. 5 is a flowchart illustrating a method for geo-positioning using two companion drones, according to an embodiment;

FIG. 6 is a flowchart illustrating a process for geo-positioning using companion drones, according to an embodiment; and

FIG. 7 is a block diagram illustrating an example machine upon which any one or more of the techniques (e.g., methodologies) discussed herein may perform, according to an embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Many conventional drones use a satellite positioning system (e.g., global positioning system (GPS), GLONASS, etc.) to determine position, velocity, or time. While satellite positioning systems provide wide-area coverage, they are less reliable in cities or other areas with numerous large buildings that block the direct path of the positioning systems' signals. As such, when a drone is being operated amongst buildings at a low altitude, the drone may not have a reliable satellite signal. This situation may lead to equipment damage, personal injury, or property damage. It may also result in failed operations, which may cost the drone operator time and money.

One proposed solution is to use terrestrial base stations. Terrestrial base stations are programmed with their fixed geolocation and broadcast the geolocation to other operating devices, such as drones. One type of terrestrial base station uses a Long-Term Evolution (LTE) cellular signal to broadcast its geolocation. However, LTE base stations have shorter range than positioning satellites and in some cases, the signals from an LTE base station may be weak or lost due to buildings, structures, radio interference, weather, or the like. Low-flying drones are used in many operations such as traffic management, crime prevention, and the like. Due to interference caused by buildings and other urban objects, for example, while operating in an urban canyon, drones may be unable to maintain reliable positioning. What is needed is a mechanism to provide reliable positioning data to a drone.

This disclosure describes a companion drone system that uses two, three, four, or more companion drones that operate above the cityscape and provide their geolocation to assist an operation drone determine its own location. Operating above the buildings and other structures in a city allows the companion drones to obtain a reliable and accurate geolocation from GPS or other positioning systems. The operation drone is then able to use the companion drones to obtain its position using trilateration.

While the term “drone” is used within this document, it is understood that the usage applies broadly to any type of autonomous or semi-autonomous robots or vehicles, which may include un-crewed vehicles, driverless cars, robots, unmanned aerial vehicles, or the like.

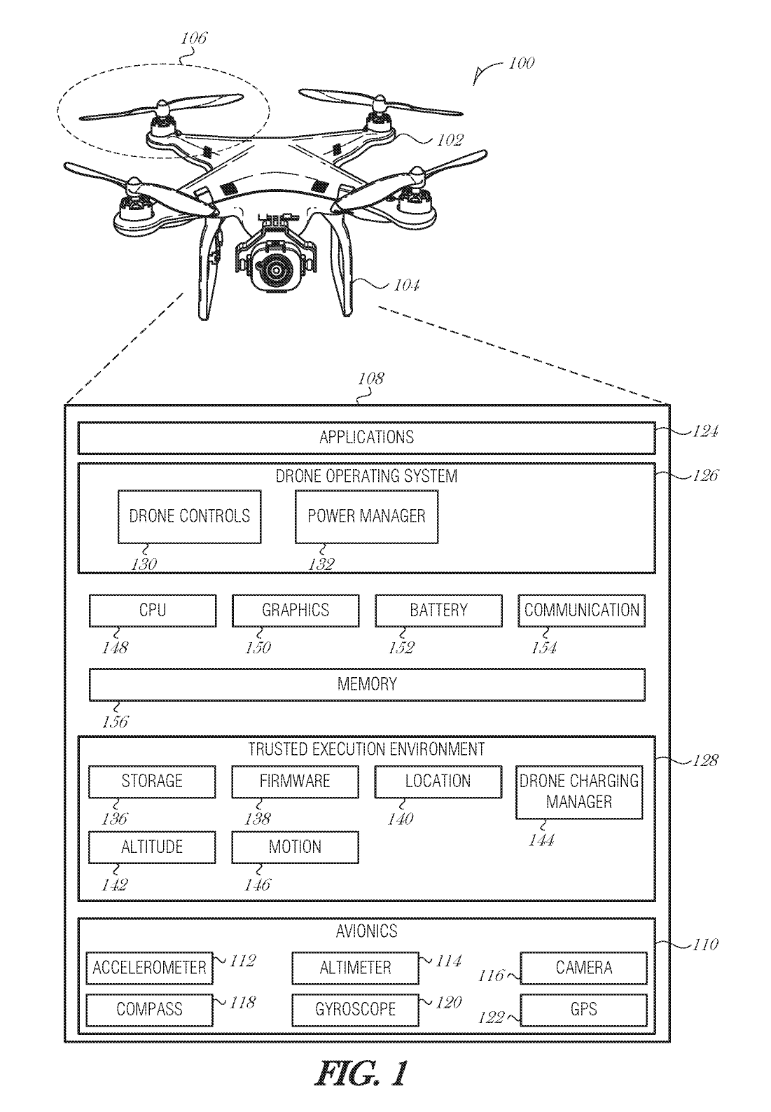

FIG. 1 is a block diagram illustrating a drone 100, according to an embodiment. The drone 100 may include an airframe 102, a landing support structure 104, a flight mechanism 106, and a control environment 108. The airframe 102 may be made of polymers, metals, etc. Other components of the drone 100 may be secured to the airframe 102.

The flight mechanism 106 may include mechanisms that propel the drone 100 through the air. For example, the flight mechanism 106 may include propellers, rotors, turbofans, turboprops, etc. The flight mechanism 106 may operably interface with avionics 110. The avionics 110 may be part of the control environment 108 (as shown in FIG. 1) or as standalone components. The avionics 110 may include an accelerometer 112, an altimeter 114, a camera 116, a compass 118, gyroscopes 120, and a global positioning system (GPS) receiver 122.

The various components of the avionics 110 may be standalone components or may be part of an autopilot system or other avionics package. For example, the altimeter 114 and GPS receiver 122 may be part of an autopilot system that include one or more axes of control. For instance, the autopilot system may be a two-axis autopilot that may maintain a preset course and hold a preset altitude. The avionics 110 may be used to control in-flight orientation of the drone 100. For example, the avionics 110 may be used to control orientation of the drone 100 about pitch, bank, and yaw axes while in flight. As the drone 100 approaches a power source, the drone 100 may need to maintain a particular angle, position, or orientation in order to facilitate coupling with the power source.

In many cases, the drone 100 operates autonomously within the parameters of some general protocol. For example, the drone 100 may be directed to deliver a package to a certain residential address or a particular geo-coordinate. The drone 100 may act to achieve this directive using whatever resources it may encounter along the way.

In other cases where the drone 100 does not operate in fully autonomous mode, the camera 116 may allow an operator to pilot the drone 100. Non-autonomous, or manual flight, may be performed for a portion of the drone's operational duty cycle, while the rest of the duty cycle is performed autonomously.

The control environment 108 may also include applications 124, a drone operating system (OS) 126, and a trusted execution environment (TEE) 128. The applications 124 may include services to be provided by the drone 100. For example, the applications 124 may include a surveillance program that may utilize the camera 116 to perform aerial surveillance. The applications 124 may include a communications program that allows the drone 100 to act as a cellular repeater or a mobile Wi-Fi hotspot. Other applications may be used to operate or add additional functionality to the drone 100. Applications may allow the drone 100 to monitor vehicle traffic, survey disaster areas, deliver packages, perform land surveys, perform in light shows, or other activities including those described elsewhere in this document. In many of these operations drones are to handle maneuvering around obstacles to locate a target.

The drone OS 126 may include drone controls 130, a power management program 132, and other components. The drone controls 130 may interface with the avionics 110 to control flight of the drone 100. The drone controls 130 may optionally be a component of the avionics 110, or be located partly in the avionics 110 and partly in the drone OS 126. The power management program 132 may be used to manage battery use. For instance, the power management program 132 may be used to determine a power consumption of the drone 100 during a flight. For example, the drone 100 may need a certain amount of energy to fly to a destination and return to base. Thus, in order to complete a roundtrip mission, the drone 100 may need a certain battery capacity. As a result, the power management program 132 may cause the drone 100 to terminate a mission and return to base.

The TEE 128 may provide secured storage 136, firmware, drivers and kernel 138, a location processing program 140, an altitude management program 142, and a motion processing program 146. The components of the TEE 128 may operate in conjunction with other components of the drone 100. The altitude management program 142 may operate with the avionics 110 during flight.

The TEE 128 may provide a secure area for storage of components used to authenticate communications between drones or between a drone and a base station. For example, the TEE 128 may store SSL certificates or other security tokens. The data stored in the TEE 128 may be read-only data such that during operation the data cannot be corrupted or otherwise altered by malware or viruses.

The control environment 108 may include a central processing unit (CPU) 148, a video/graphics card 150, a battery 152, a communications interface 154, and a memory 156. The CPU 148 may be used to execute operations, such as those described herein. The video/graphics card 150 may be used to process images or video captured by the camera 116. The memory 156 may store data received by the drone 100 as well as programs and other software utilized by the drone 100. For example, the memory 156 may store instructions that, when executed by the CPU 148, cause the CPU 148 to perform operations such as those described herein.

The battery 152 may provide power to the drone 100. While FIG. 1 shows a single battery, more than one battery may be utilized with drone 100. While FIG. 1 shows various components of the drone 100, not all components shown in FIG. 1 are required. More or fewer components may be used on a drone 100 according to the design and use requirements of the drone 100.

The drone 100 may be an unmanned aerial vehicle (UAV), such as is illustrated in FIG. 1, in which case it includes one or more flight mechanisms (e.g., flight mechanism 106) and corresponding control systems (e.g., control environment 108). The drone may alternatively be a terrestrial drone, in which case it may include various wheels, tracks, legs, propellers, or other mechanisms to traverse over land. The drone may also be an aquatic drone, in which case it may use one of several types of marine propulsion mechanisms, such as a prop (propeller), jet drive, paddle wheel, whale-tail propulsion, or other type of propul sor.

The duty cycle of a companion drone may be relatively redundant. For example, the companion drone may be programmed or configured to rise to a specific altitude (e.g., 500 m), hold at that latitude-longitude position and altitude for a certain amount of time (e.g., 20 minutes), and then descend to the operating base to recharge. The companion drone may operate in a fleet of drones to provide an around-the-clock service to operation drones in the area.

While hovering, the companion drone may be configured or programmed to receive positioning data packets from operation drones and respond in a certain manner, allowing the operation drone to determine its distance from the companion drone. Communication protocols are discussed further below.

Operation drones may be programmed or otherwise configured to perform a task of their own, such as to surveille an area by moving from waypoint to waypoint or by traversing a boundary of a geofence, for example. Other tasks may include package delivery, traffic monitoring, news coverage, or the like. Additionally, an operation drone may be operated partially or fully manually by a human user. In whatever manner the operation drone is being used, the operation drone may periodically check its assumed location by using the geolocations of the companion drones. For instance, while flying, an operation drone may periodically halt and hover to get exact geocoordinates from companion drones and calculate its exact location. The operation drone may be configured to perform this check at any interval, such as every three minutes, five minutes, etc.

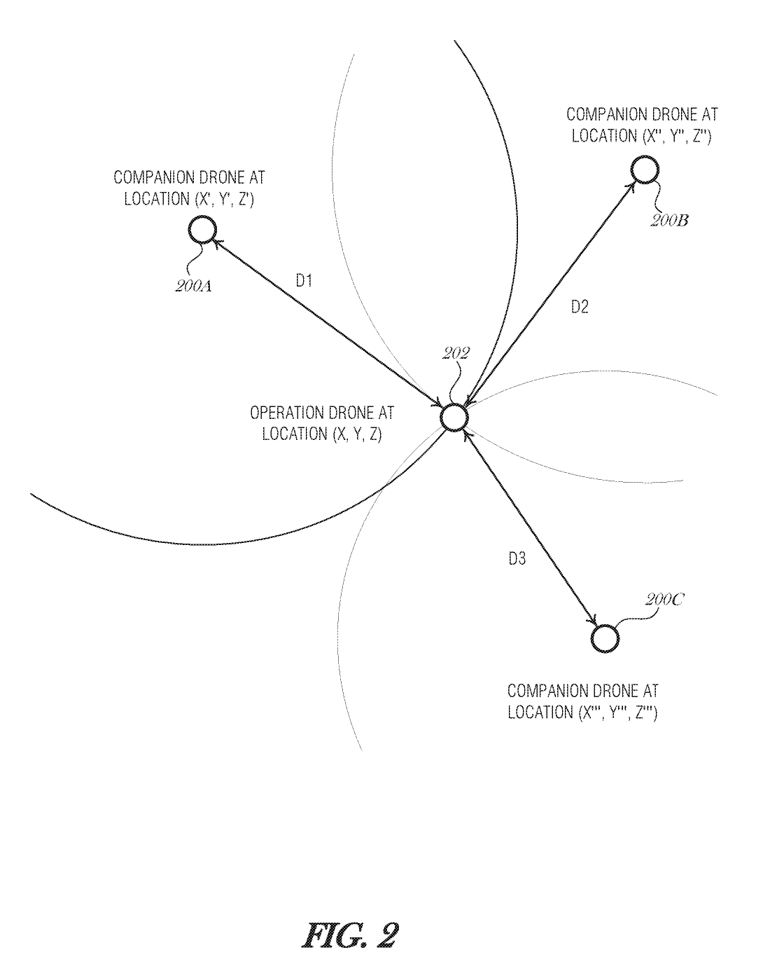

FIG. 2 is a diagram illustrating trilateration with three companion drones 200A, 200B, and 200C, according to an embodiment. Companion drone 200A, companion drone 200B, and companion drone 200C (collectively referred to as companion drones 200) are programmed or configured to hover at or near a fixed location. The companion drones 200 operate at an altitude that is high enough to avoid some or all of structural interface that may be caused by man-made objects, such as buildings, or natural objects, such as trees. The companion drones 200 are able to obtain an accurate geolocation from one or more positioning systems, such as GPS, so that they each know their own location with high accuracy and certainty. While companion drones 200 may be configured to hover, in some other embodiments, companion drones 200 operating in a flight pattern. Doing so may be more power efficient than hovering, for example, by using drones with fixed wings and good glide characteristics. Companion drones 200 may be of the same type of drone or of different types or models (e.g., a fixed-wing glider or a quad-copter), including aerial drones, terrestrial drones, or other types of autonomous robots or vehicles.

An operation drone 202 operating in communication range of the companion drones 200 may periodically request location information from the companion drones 200 using a particular message. Operation drone 2020 flies low enough to get have good ground visibility for its operation. The message passing protocol is described in the next section. Based on the time it takes to receive the companion drones' responses, the operation drone 202 is able to determine d1, d2, and d3.

In an embodiment, the time-to-receive the message sent by a companion drone 200 is calculated by the operation drone 202 from the timestamp in the message. The calculation is based on the time of flight (TOF) of the packet in transit between the companion drone 200 and the operation drone 202. To ensure accuracy in determining the distance values d1, d2, and d3, the clocks on each of the companion drones 200 and the operation drone 202 should be synchronized and of a type that is highly accurate and does not experience much drift. Error correction may be used to adjust for an offset between the clock of the operation drone 202 and the clock of one or more of the companion drones 200.

In an alternative embodiment, the round-trip-time (RTT) is used to calculate the distance. For instance, the operation drone 202 may mark the time that it transmits the request to the companion drone 200. The companion drone 200 may track how much processing latency occurs to receive the request message, construct a response message, and transmit the response message. The processing latency may be included in the response message so that the operation drone 202 may reduce the total RTT by the processing latency to determine two times the TOF (e.g., to and from the companion drone). Using this mechanism eliminates the need for clock synchronization between the companion drones 200 and the operation drone 202. However, the companion drones 200 are required to calculate processing latency and transmit that data to the operation drone 202.

Other mechanism or processes may be used to determine the distance between the operation drone 202 and the companion drones 200. For instance, a time-of-flight camera may be used to determine the range, or image analysis that analyzes scale, or radar, sonar, or other ranging technologies may be used.

In addition to the time the response message was sent, each companion drone's response includes a three-dimensional position in (x, y, z), or (latitude, longitude, altitude), where the altitude is the “true altitude,” i.e., the actual height above sea level. Assuming that companion drone 200A has a {latitude, longitude, altitude} tuple of (x′, y′, z′), companion drone 200B has a {latitude, longitude, altitude} tuple of (x″, y″, z″), and companion drone 200C has a {latitude, longitude, altitude} tuple of (x′″, y′″, z′″), then the system of equations to be solved is:

(x′−x)²+(y′−y)²+(z′−z)²=d1² Eq. 1

(x″−x)²+(y″−y)²+(z″−z)²=d2² Eq. 2

(x′″−x)²+(y′″−y)²+(z′″−z)²=d3² Eq. 3

where (x, y, z) is the location of the operation drone 202 and represents the values to be solved for, d1 is the distance from companion drone 200A to the operation drone 202, d2 is the distance from companion drone 200B to the operation drone 202, and d3 is the distance from companion drone 200C to the operation drone 202. Because (x′, y′, z′), (x″, y″, z″), (x′″, y′″, z′″), d1, d2, and d3 are known values, the solution for (x, y, z) is a straightforward using a system of equations.

In some embodiments, the value of z is known as well because the operation drone 202 is equipped with an altimeter 114. In this instance, solving the system of equations Eq. 1, Eq. 2, and Eq. 2 is made simpler.

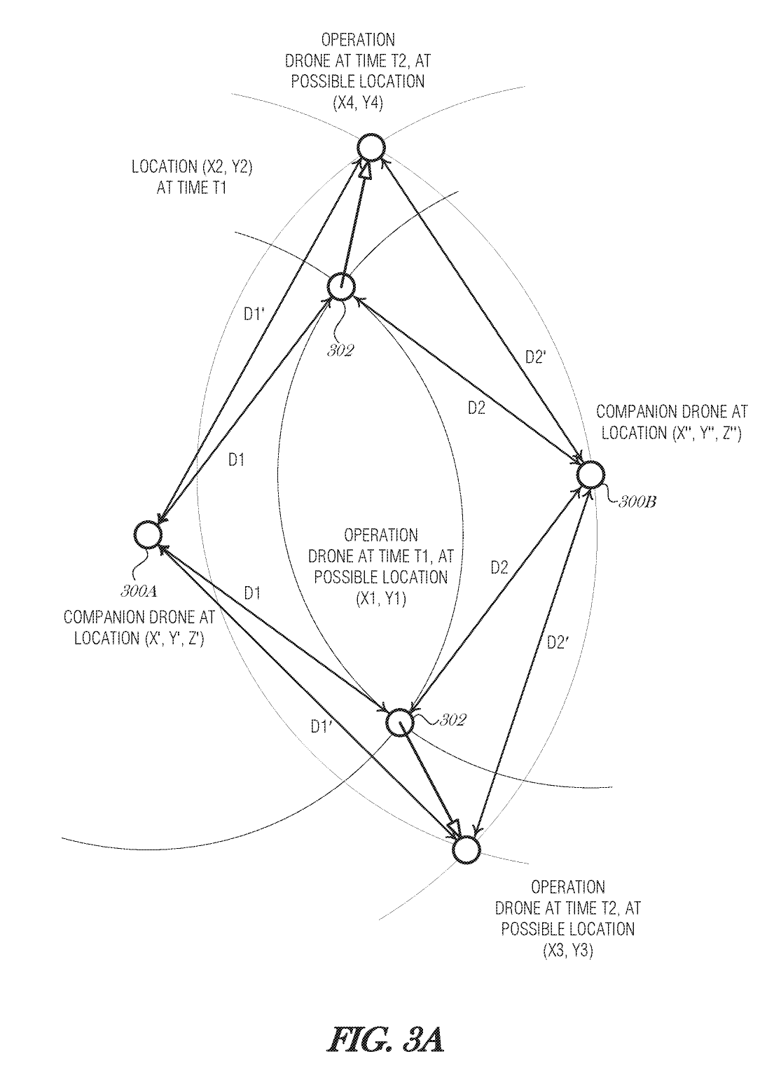

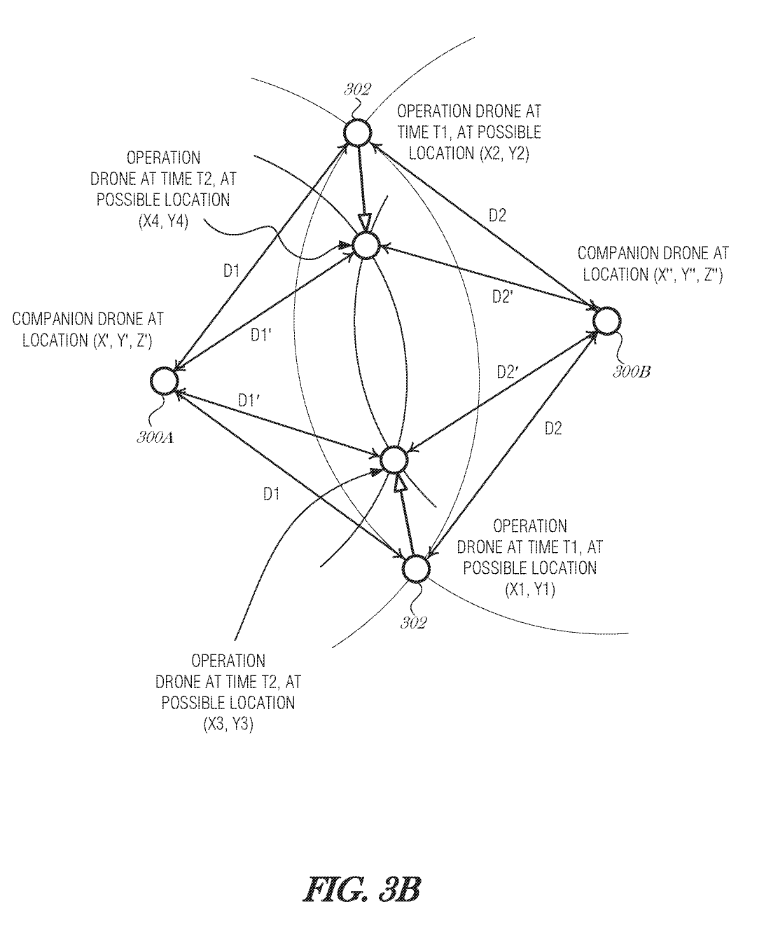

FIGS. 3A-3B are diagrams illustrating trilateration with two companion drones 300A and 300B, according to various embodiments. Similar to the situation illustrated in FIG. 2, an operation drone 302 is operating in an area that has communication range with two companion drones 300A, 300B (collectively referred to as 300). As with the embodiment discussed above in FIG. 2, companion drones 300 may be of the same type of drone or of different types or models (e.g., a fixed-wing glider or a quad-copter), including aerial drones, terrestrial drones, or other types of autonomous robots or vehicles.

When using two companion drones 300 instead of three, only two of the three coordinates may be solved (e.g., latitude and longitude, but not altitude). This is acceptable because altitude may be obtained by sensors onboard the operation drone 302 (e.g., altimeter 114).

The operation drone 302 transmits a message to each companion drone 300. The time to receive the response message is determined and based on the speed of light, the distance between the operation drone 302 and each of the companion drones 300 is calculated. The response message from each companion drone 300 includes the latitude, longitude, and altitude of the companion drone 300 at the time the response was transmitted to the operation drone 302. Based on the equations Eq. 1 and Eq. 2 from above, one is able to solve for (x, y) as z′, z″, z, d1, and d2 are known.

However, when using two companion drones 300, the solution of the equations results two possible coordinates at time T1: (x1, y1) and (x2, y2). In order to determine the correct solution, a second message is transmitted to each companion drone 300 and a second response is received at time T2. Assuming that the operation drone 302 is moving faster than the companion drones 300, then when analyzing the second response message, a second set of coordinates are calculated at time T2: (x3, y3) and (x4, y4). Using onboard sensors to determine the direction of travel, the operation drone 302 is able to select the correct coordinate from the second set of coordinates.

The timing between the first and second messages may be relatively short, such as 0.5 s or one second, for example. By using a short period between the first and second message transmission/receipt, companion drone movement is largely factored out of the calculations.

As illustrated in FIG. 3A, at a first time T1, the operation drone 302 transmits a query and receives responsive messages from the companion drones 300, and solves for two possible locations (x1, y1) and (x2, y2). At a second time T2, the operation drone 302 transmits a second query and receives responsive messages. The operation drone 302 is able to solve for distances d1′ to companion drone 300A and distance d2′ to companion drone 300B based on the responsive messages. Using these distances d1′ and d2′, the operation drone 302 identifies the second set of possible locations (x3, y3) and (x4, y4). Based on compass readings to determine heading, the operation drone 302 is able to determine if the correct location at time T2 is (x3, y3) (e.g., when the compass reading indicates northward), or (x4, y4) (e.g., when the compass reading indicates southward). The compass may be a part of the GPS unit (e.g., GPS receiver 122) or exist as a separate device in the drone (e.g., compass 118).

FIG. 3B is diagram illustrating another situation where the operation drone 302 solves for a second set of possible locations (x3, y3) and (x4, y4) at time T2, based on communications with the respective companion drones 300. Based on compass readings to determine heading, the operation drone 302 is able to determine if the correct location at time T2 is (x3, y3) (e.g., when the compass reading indicates southward), or (x4, y4) (e.g., when the compass reading indicates northward).

Note that in the case where the companion drone 302 is moving on a line that parallels an imaginary line connecting the two companion drones 300, the heading will be the same for each of second set of possible locations. As such, is it indeterminate which of the two coordinates from the second set of possible locations is the correct one. In this case, additional measurements may be taken at later times. At some point, the operation drone 302 will move away from the parallel path and the correct location at time Tₙ will be determinate.

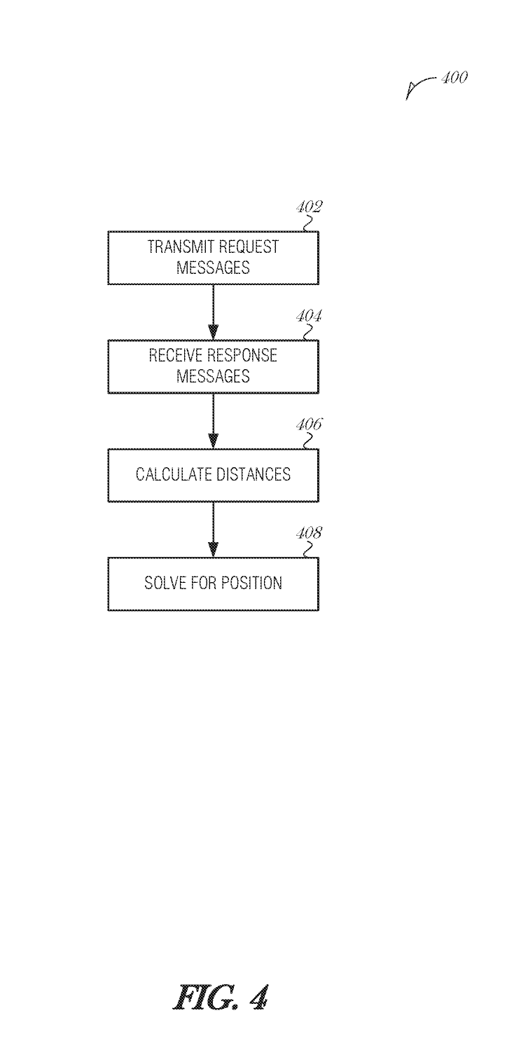

FIG. 4 is a flowchart illustrating a method 400 for geo-positioning using three or more companion drones, according to an embodiment. At 402, an operation drone transmits messages to each of the three companion drones. The messages may be the same (e.g., broadcast to all companion drones in communication range) or may be individualized for each companion drone. For instance, in an example, the operation drone broadcasts a message (e.g., a request message or an initiation message). In another example, the operation drone maintains locations of companion drones in the area and transmits messages for each of the companion drones. The individualized messages may include a companion drone identifier, a companion drone address, or other indication of the intended recipient.

At 404, the operation drone receives responses from the companion drones. The responses include data and information that the operation drone may use to determine how far away each companion drone is from the operation drone. In the case where a general broadcast message is used, the response message may include a processing latency time indicating how much time was spent by the companion drone to receive the request broadcast, process it, and transmit the response message. Alternatively, in the case where the operation drone transmits individualized messages to each of the companion drones, the response may include authentication information indicating that the message was received by the proper drone along with timing information.

In addition to timing information, which may be processing latency, a timestamp, an offset from a globally synchronized clock, or other information, the response message may also include the three-dimensional positioning information of the responding companion drone (e.g., the latitude, longitude, and altitude).

At 406, based on the response message from a particular companion drone, the distance from the operation drone to the particular companion drone is calculated. The operation drone may calculate a round-trip time (RTT) from the time it sent the request message to the time it received the response message. The RTT may include some processing overhead (e.g., processing latency) that represents the time the companion drone took to receive the request message and transmit the response. So, to calculate the distance, the RTT is reduced by any processing latency time, which may be included in the response message. Then the RTT is divided in half and a straightforward calculating using the speed of light is used to determine the distance. Referring to FIG. 2, for example, the distance may be any one of d1, d2, or d3, depending on which companion drone sent the response message.

Alternatively, in another embodiment, the response message may include a timestamp indicating when the companion drone transmitted the response message to the operation drone. The operation drone may then subtract the timestamped time from the current time to determine a time-of-fight (TOF) of the response message. The distance is solved using the same equation as above, c·Δt, where c is the speed of light and Δt is the time difference.

With three or fewer companion drones, the real-time clocks of the companion drones and the operation drone should be in close synchronicity. All drones may periodically synchronize with a global reference, such as a time server with an atomic clock. Alternatively, the companion drones may calculate the current time from GPS satellites and the operation drone may synchronize its clock with a companion drone.

When there are four or more companion drones used by the operation drone, then the companion drones' time values may be used to calculate the operation drone's clock. With four or more companion drones, the operation drone's position should be known absolutely—with one companion drone distance, the solution is anywhere in a sphere, with two companion drones, the solution becomes a circle (intersection of the spheres), with three companion drones, the solution becomes one of two points, and with four companion drones, the solution is a single point. So, with four or more companion drones, after solving the initial computations for distance from each of the companion drones, the operation drone is able to refine the solution by solving the problem backwards and adjusting the operation drone's unsynchronized time to minimize the error.

At 408, the operation drone computes its position. For example, the companion drone may determine its own altitude from an onboard sensor and then solve the system of equations (Eq. 1, Eq. 2, and Eq. 3).

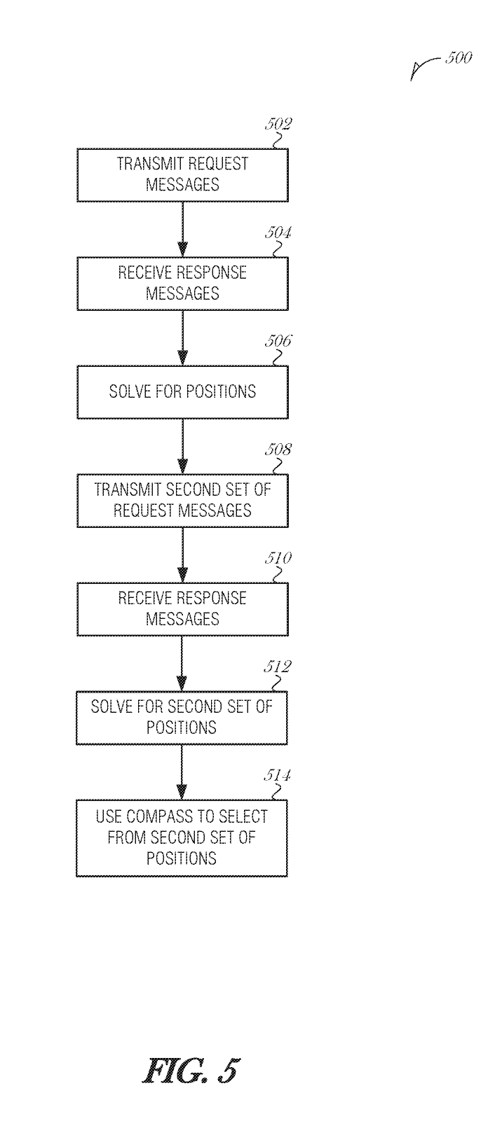

FIG. 5 is a flowchart illustrating a method 500 for geo-positioning using two companion drones, according to an embodiment. At 502, a request message is transmitted from the operation drone to the companion drones. As with the process illustrated in FIG. 4, the request message may be a broadcast message for any companion drones to respond to, or may be a point-to-point message that is addressed to a specific companion drone.

At 504, the operation drone receives the response messages from the companion drones. Based on the implementation in use, the response message may be formatted in various ways. In an embodiment, the response message includes a companion drone identifier, a timestamp indicating when the response message was transmitted by the companion drone, and a companion drone position (e.g., latitude, longitude, and altitude).

At 506, the operation drone uses the companion drone response messages to determine the two possible positions of the operation drone (as illustrated in FIGS. 3A-B as (x1, y1) and (x2, y2)).

At 508, a second set of request messages is sent to the companion drones, essentially repeating operation 502. The responses are received (operation 510), and are used to determine a second set of possible positions (e.g., (x3, y3) and (x4, y4) of FIG. 3A or FIG. 3B) (operation 512). At 514, based on compass readings indicating heading, the operation drone selects one position from the second set of possible positions.

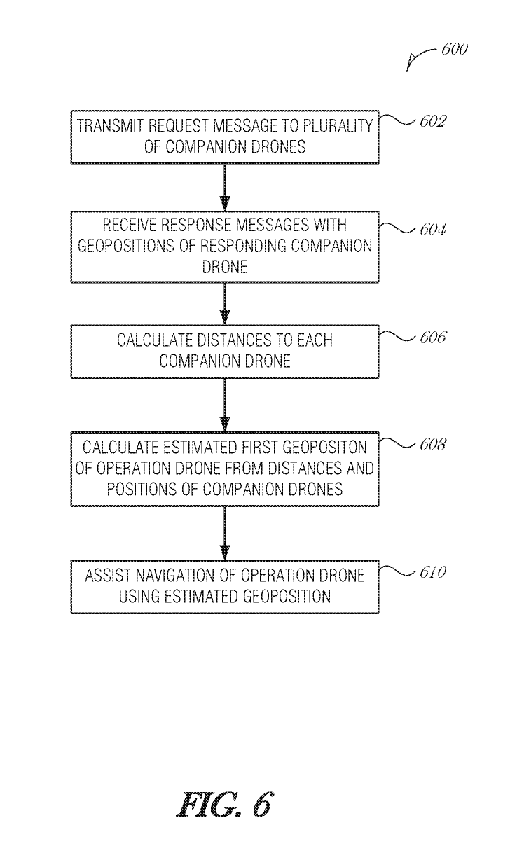

FIG. 6 is a flowchart illustrating a process 600 for geo-positioning using companion drones, according to an embodiment. At 602, an operation drone transmits a request message to a plurality of companion drones.

At 604, a response message from each of the plurality of companion drones is received at the operation drone, where each response message includes: a first timestamp indicating when the response message was sent from the corresponding companion drone and a first geoposition of the corresponding companion drone.

At 606, a first distance to each of the plurality of companion drones is calculated using the first timestamps of respective response messages from each of the plurality of companion drones.

At 608, an estimated geoposition of the operation drone is calculated from the respective first distances and the respective first geopositions of the companion drones.

At 610, the operation drone uses the estimated geoposition to assist navigation.

In an embodiment, the request message is addressed to a particular companion drone. In a related embodiment, the request message is broadcasted to the plurality of companion drones.

In an embodiment, calculating the estimated geoposition of the operation drone includes solving a system of equations using the respective first distances to each of the plurality of companion drones and the respective first geopositions of the companion drones. In a further embodiment, calculating the estimated geoposition of the operation drone includes obtaining an altitude measurement of the operation drone and using the altitude measurement in solving the system of equations.

In an embodiment, the plurality of companion drones includes two drones, and the estimated geoposition is one of two possible geopositions. In such an embodiment, calculating the estimated geoposition of the operation drone includes transmitting a second request message and receiving corresponding response messages from the plurality of companion drones, each response message including: a second timestamp indicating when the response message was sent from the corresponding companion drone and a second geoposition of the corresponding companion drone. Then, second estimated geopositions of the operation drone are calculated from the respective second timestamps and the respective second geopositions of the plurality of companion drones. A refined geoposition of the operation drone is selected from the second estimated geopositions, based on a compass reading indicating a heading of the operation drone.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

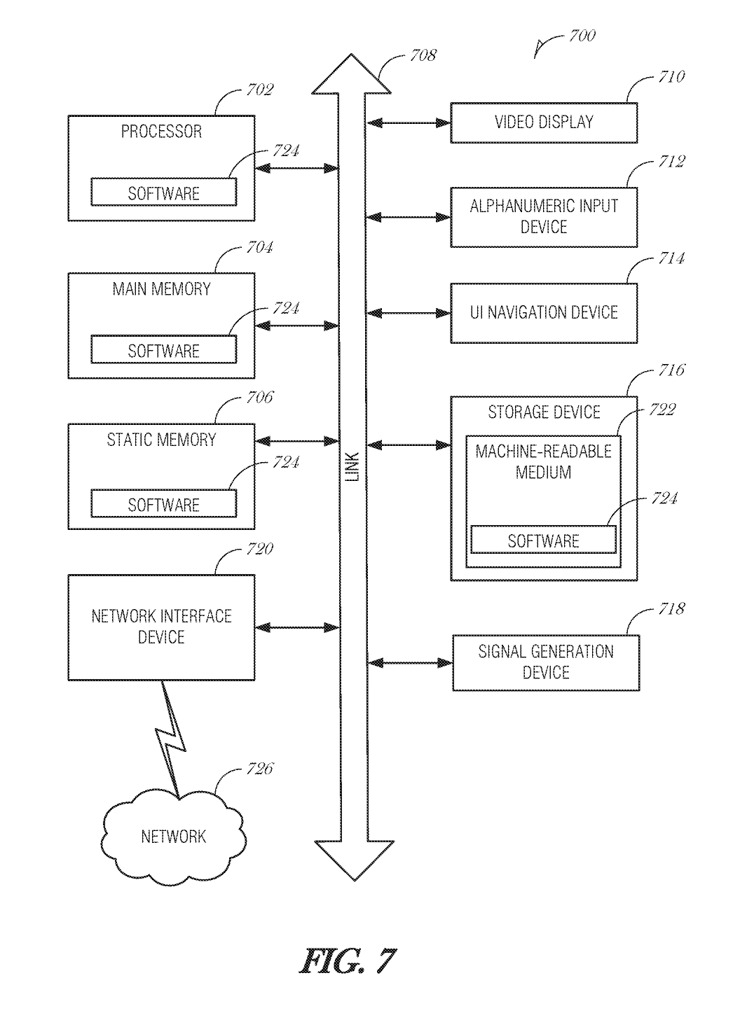

FIG. 7 is a block diagram illustrating a machine in the example form of a computer system 700, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a component in an autonomous vehicle, a component of a drone, or incorporated in a wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a drone positioning system, the system comprising: a processor subsystem; and memory comprising instructions, which when executed by the processor subsystem, cause the processor subsystem to perform the operations comprising: transmitting, from an operation drone, a request message to a plurality of companion drones; receiving a response message from each of the plurality of companion drones, each response message including: a first timestamp indicating when the response message was sent from the corresponding companion drone and a first geoposition of the corresponding companion drone; calculating a first distance to each of the plurality of companion drones using the first timestamps of respective response messages from each of the plurality of companion drones; calculating an estimated geoposition of the operation drone from the respective first distances and the respective first geopositions of the companion drones; and assisting navigation of the operation drone using the estimated geoposition.

In Example 2, the subject matter of Example 1 includes, wherein the request message is addressed to a particular companion drone.

In Example 3, the subject matter of Examples 1-2 includes, wherein the request message is broadcasted to the plurality of companion drones.

In Example 4, the subject matter of Examples 1-3 includes, wherein calculating the estimated geoposition of the operation drone comprises solving a system of equations using the respective first distances to each of the plurality of companion drones and the respective first geopositions of the companion drones.

In Example 5, the subject matter of Example 4 includes, wherein calculating the estimated geoposition of the operation drone comprises: obtaining an altitude measurement of the operation drone; and using the altitude measurement in solving the system of equations.

In Example 6, the subject matter of Examples 1-5 includes, wherein the plurality of companion drones includes two drones, and wherein the estimated geoposition is one of two possible geopositions; and wherein calculating the estimated geoposition of the operation drone comprises: transmitting a second request message and receiving corresponding response messages from the plurality of companion drones, each response message including: a second timestamp indicating when the response message was sent from the corresponding companion drone and a second geoposition of the corresponding companion drone; calculating second estimated geopositions of the operation drone from the respective second timestamps and the respective second geopositions of the plurality of companion drones; and selecting a refined geoposition of the operation drone from the second estimated geopositions, based on a compass reading indicating a heading of the operation drone.

Example 7 is a method of geopositioning using companion drones, the method comprising: transmitting, from an operation drone, a request message to a plurality of companion drones; receiving a response message from each of the plurality of companion drones, each response message including: a first timestamp indicating when the response message was sent from the corresponding companion drone and a first geoposition of the corresponding companion drone; calculating a first distance to each of the plurality of companion drones using the first timestamps of respective response messages from each of the plurality of companion drones; calculating an estimated geoposition of the operation drone from the respective first distances and the respective first geopositions of the companion drones; and assisting navigation of the operation drone using the estimated geoposition.

In Example 8, the subject matter of Example 7 includes, wherein the request message is addressed to a particular companion drone.

In Example 9, the subject matter of Examples 7-8 includes, wherein the request message is broadcasted to the plurality of companion drones.

In Example 10, the subject matter of Examples 7-9 includes, wherein calculating the estimated geoposition of the operation drone comprises solving a system of equations using the respective first distances to each of the plurality of companion drones and the respective first geopositions of the companion drones.

In Example 11, the subject matter of Example 10 includes, wherein calculating the estimated geoposition of the operation drone comprises: obtaining an altitude measurement of the operation drone; and using the altitude measurement in solving the system of equations.

In Example 12, the subject matter of Examples 7-11 includes, wherein the plurality of companion drones includes two drones, and wherein the estimated geoposition is one of two possible geopositions; and wherein calculating the estimated geoposition of the operation drone comprises: transmitting a second request message and receiving corresponding response messages from the plurality of companion drones, each response message including: a second timestamp indicating when the response message was sent from the corresponding companion drone and a second geoposition of the corresponding companion drone; calculating second estimated geopositions of the operation drone from the respective second timestamps and the respective second geopositions of the plurality of companion drones; and selecting a refined geoposition of the operation drone from the second estimated geopositions, based on a compass reading indicating a heading of the operation drone.

Example 13 is at least one machine-readable medium including instructions, which when executed by a machine, cause the machine to perform operations of any of the methods of Examples 7-12.

Example 14 is an apparatus comprising means for performing any of the methods of Examples 7-12.

Example 15 is an apparatus for geopositioning using companion drones, the apparatus comprising: means for transmitting, from an operation drone, a request message to a plurality of companion drones; means for receiving a response message from each of the plurality of companion drones, each response message including: a first timestamp indicating when the response message was sent from the corresponding companion drone and a first geoposition of the corresponding companion drone; means for calculating a first distance to each of the plurality of companion drones using the first timestamps of respective response messages from each of the plurality of companion drones; means for calculating an estimated geoposition of the operation drone from the respective first distances and the respective first geopositions of the companion drones; and means for assisting navigation of the operation drone using the estimated geoposition.

In Example 16, the subject matter of Example 15 includes, wherein the request message is addressed to a particular companion drone.

In Example 17, the subject matter of Examples 15-16 includes, wherein the request message is broadcasted to the plurality of companion drones.

In Example 18, the subject matter of Examples 15-17 includes, wherein the means for calculating the estimated geoposition of the operation drone comprise means for solving a system of equations using the respective first distances to each of the plurality of companion drones and the respective first geopositions of the companion drones.

In Example 19, the subject matter of Example 18 includes, wherein the means for calculating the estimated geoposition of the operation drone comprise: means for obtaining an altitude measurement of the operation drone; and means for using the altitude measurement in solving the system of equations.

In Example 20, the subject matter of Examples 15-19 includes, wherein the plurality of companion drones includes two drones, and wherein the estimated geoposition is one of two possible geopositions; and wherein the means for calculating the estimated geoposition of the operation drone comprise: means for transmitting a second request message and receiving corresponding response messages from the plurality of companion drones, each response message including: a second timestamp indicating when the response message was sent from the corresponding companion drone and a second geoposition of the corresponding companion drone; means for calculating second estimated geopositions of the operation drone from the respective second timestamps and the respective second geopositions of the plurality of companion drones; and means for selecting a refined geoposition of the operation drone from the second estimated geopositions, based on a compass reading indicating a heading of the operation drone.

Example 21 is at least one machine-readable medium including instructions for geopositioning using companion drones, the instructions when executed by a machine, cause the machine to perform the operations comprising: transmitting, from an operation drone, a request message to a plurality of companion drones; receiving a response message from each of the plurality of companion drones, each response message including: a first timestamp indicating when the response message was sent from the corresponding companion drone and a first geoposition of the corresponding companion drone; calculating a first distance to each of the plurality of companion drones using the first timestamps of respective response messages from each of the plurality of companion drones; calculating an estimated geoposition of the operation drone from the respective first distances and the respective first geopositions of the companion drones; and assisting navigation of the operation drone using the estimated geoposition.

In Example 22, the subject matter of Example 21 includes, wherein the request message is addressed to a particular companion drone.

In Example 23, the subject matter of Examples 21-22 includes, wherein the request message is broadcasted to the plurality of companion drones.

In Example 24, the subject matter of Examples 21-23 includes, wherein calculating the estimated geoposition of the operation drone comprises solving a system of equations using the respective first distances to each of the plurality of companion drones and the respective first geopositions of the companion drones.

In Example 25, the subject matter of Example 24 includes, wherein calculating the estimated geoposition of the operation drone comprises: obtaining an altitude measurement of the operation drone; and using the altitude measurement in solving the system of equations.

In Example 26, the subject matter of Examples 21-25 includes, wherein the plurality of companion drones includes two drones, and wherein the estimated geoposition is one of two possible geopositions; and wherein calculating the estimated geoposition of the operation drone comprises: transmitting a second request message and receiving corresponding response messages from the plurality of companion drones, each response message including: a second timestamp indicating when the response message was sent from the corresponding companion drone and a second geoposition of the corresponding companion drone; calculating second estimated geopositions of the operation drone from the respective second timestamps and the respective second geopositions of the plurality of companion drones; and selecting a refined geoposition of the operation drone from the second estimated geopositions, based on a compass reading indicating a heading of the operation drone.

Example 27 is at least one machine-readable medium including instructions that, when executed by processing circuitry, cause the processing circuitry to perform operations to implement of any of Examples 1-26.

Example 28 is an apparatus comprising means to implement of any of Examples 1-26.

Example 29 is a system to implement of any of Examples 1-26.

Example 30 is a method to implement of any of Examples 1-26.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A drone positioning system, the system comprising:
a processor subsystem; and
memory comprising instructions, which when executed by the processor subsystem, cause the processor subsystem to perform the operations comprising:
transmitting, from an operation drone, a request message to a plurality of companion drones;
receiving a response message from each of the plurality of companion drones, each response message including: a first timestamp indicating when the response message was sent from the corresponding companion drone and a first geoposition of the corresponding companion drone;
calculating a first distance to each of the plurality of companion drones using the first timestamps of respective response messages from each of the plurality of companion drones;
calculating an estimated geoposition of the operation drone from the respective first distances and the respective first geopositions of the companion drones; and
assisting navigation of the operation drone using the estimated geoposition.

2. The system of claim 1, wherein the request message is addressed to a particular companion drone.

3. The system of claim 1, wherein the request message is broadcasted to the plurality of companion drones.

4. The system of claim 1, wherein calculating the estimated geoposition of the operation drone comprises solving a system of equations using the respective first distances to each of the plurality of companion drones and the respective first geopositions of the companion drones.

5. The system of claim 4, wherein calculating the estimated geoposition of the operation drone comprises:
obtaining an altitude measurement of the operation drone; and
using the altitude measurement in solving the system of equations.

6. The system of claim 1, wherein the plurality of companion drones includes two drones, and wherein the estimated geoposition is one of two possible geopositions; and
wherein calculating the estimated geoposition of the operation drone comprises:
transmitting a second request message and receiving corresponding response messages from the plurality of companion drones, each response message including: a second timestamp indicating when the response message was sent from the corresponding companion drone and a second geoposition of the corresponding companion drone;
calculating second estimated geopositions of the operation drone from the respective second timestamps and the respective second geopositions of the plurality of companion drones; and
selecting a refined geoposition of the operation drone from the second estimated geopositions, based on a compass reading indicating a heading of the operation drone.

7. A method of geopositioning using companion drones, the method comprising:
transmitting, from an operation drone, a request message to a plurality of companion drones;
receiving a response message from each of the plurality of companion drones, each response message including: a first timestamp indicating when the response message was sent from the corresponding companion drone and a first geoposition of the corresponding companion drone;
calculating a first distance to each of the plurality of companion drones using the first timestamps of respective response messages from each of the plurality of companion drones;
calculating an estimated geoposition of the operation drone from the respective first distances and the respective first geopositions of the companion drones; and
assisting navigation of the operation drone using the estimated geoposition.

8. The method of claim 7, wherein the request message is addressed to a particular companion drone.

9. The method of claim 7, wherein the request message is broadcasted to the plurality of companion drones.

10. The method of claim 7, wherein calculating the estimated geoposition of the operation drone comprises solving a system of equations using the respective first distances to each of the plurality of companion drones and the respective first geopositions of the companion drones.

11. The method of claim 10, wherein calculating the estimated geoposition of the operation drone comprises:
obtaining an altitude measurement of the operation drone; and
using the altitude measurement in solving the system of equations.

12. The method of claim 7, wherein the plurality of companion drones includes two drones, and wherein the estimated geoposition is one of two possible geopositions; and
wherein calculating the estimated geoposition of the operation drone comprises:
transmitting a second request message and receiving corresponding response messages from the plurality of companion drones, each response message including: a second timestamp indicating when the response message was sent from the corresponding companion drone and a second geoposition of the corresponding companion drone;
calculating second estimated geopositions of the operation drone from the respective second timestamps and the respective second geopositions of the plurality of companion drones; and
selecting a refined geoposition of the operation drone from the second estimated geopositions, based on a compass reading indicating a heading of the operation drone.

13. At least one machine-readable medium including instructions for geopositioning using companion drones, the instructions when executed by a machine, cause the machine to perform the operations comprising:
transmitting, from an operation drone, a request message to a plurality of companion drones;
receiving a response message from each of the plurality of companion drones, each response message including: a first timestamp indicating when the response message was sent from the corresponding companion drone and a first geoposition of the corresponding companion drone;
calculating a first distance to each of the plurality of companion drones using the first timestamps of respective response messages from each of the plurality of companion drones;
calculating an estimated geoposition of the operation drone from the respective first distances and the respective first geopositions of the companion drones; and
assisting navigation of the operation drone using the estimated geoposition.

14. The at least one machine-readable medium of claim 13, wherein the request message is addressed to a particular companion drone.

15. The at least one machine-readable medium of claim 13, wherein the request message is broadcasted to the plurality of companion drones.

16. The at least one machine-readable medium of claim 13, wherein calculating the estimated geoposition of the operation drone comprises solving a system of equations using the respective first distances to each of the plurality of companion drones and the respective first geopositions of the companion drones.

17. The at least one machine-readable medium of claim 16, wherein calculating the estimated geoposition of the operation drone comprises:
obtaining an altitude measurement of the operation drone; and
using the altitude measurement in solving the system of equations.

18. The at least one machine-readable medium of claim 13, wherein the plurality of companion drones includes two drones, and wherein the estimated geoposition is one of two possible geopositions; and
wherein calculating the estimated geoposition of the operation drone comprises:
transmitting a second request message and receiving corresponding response messages from the plurality of companion drones, each response message including: a second timestamp indicating when the response message was sent from the corresponding companion drone and a second geoposition of the corresponding companion drone;
calculating second estimated geopositions of the operation drone from the respective second timestamps and the respective second geopositions of the plurality of companion drones; and
selecting a refined geoposition of the operation drone from the second estimated geopositions, based on a compass reading indicating a heading of the operation drone.
